(19) United States
(12) Patent Application Publication
(10) Pub. No.: US 2001/0056478 A1
(43) Pub. Date: Dec. 27, 2001

(54) Coordinated internet web site and web browser using a CD-ROM

(75) Inventors: Tyler Wheeler, Fresno, CA (US); Larry Wheeler, Fresno, CA (US); Chris Hoyt, Clovis, CA (US); Nasser Hamedani, Lafayette, CA (US)

Correspondence Address: Crosby, Heafey, Roach & May, P.O. Box 7936, San Francisco, CA, 94120-7936, US

(73) Assignee: TWO DOG NET, INC.

(21) Appl. No.: 09/791,012

(22) Filed: Feb. 22, 2001

Related U.S. Application Data
(62) Division of application No. 08/767,232, filed on Dec. 13, 1996.

(51) Int. Cl. G06F 15/16

(52) U.S. Cl. 709/219

(57) ABSTRACT

An integrated system for coordinating a web site with a web browser using a storage medium which is local to the user, such that the user may interactively obtain information specified on the web site without experiencing great delays. A user having a browser also has access to a local storage medium, such as a CD-ROM, which contains information specified on the web site which requires long transmission times over public telephone lines. When the user requests information, if the server determines that the requested information is located on the CD-ROM, the user's browser retrieves the data from the CD-ROM rather than from the website, thus greatly shortening the time necessary for the user to access the information. Access to the CD-ROM may also be protected by password or encryption, so that the user must submit- appropriate payment before being permitted to access the information.

### BACKGROUND OF THE INVENTION

1. Technical Field

The present invention relates generally to the computer network known as the Internet, and more particularly to that portion of the Internet known as the World Wide Web. This area has recently generated great interest, as computer users expect to quickly obtain high quality multimedia presentations over the Web. However, due to the bandwidth limitations of telephone lines, most users find that these expectations are as yet unrealized. Also, providers of content information are still struggling with the issue of how to collect payment for that content, and how to prevent certain users, such as children, from accessing information deemed inappropriate for them, such as pornographic material.

2. Background Art

The Internet and the World Wide Web can provide wide access to information. By the use of a personal computer and software known as a browser, a user can obtain information across public telephone lines from a website located on a server in virtually any country in the world.

However, the use of public telephone lines is both a boon and a bane. While many people already have access to a telephone line, that line has a limited bandwidth, since it was originally designed to carry only audio signals in the narrow frequency range of the human voice. As a result, the highest speed at which most modems in common use can operate is 28,800 bits per second. While this allows for reasonably quick transmission of text, the transmission speed of more complex information available on the Web (higher quality sound, graphics, video, etc.) is quite slow. It can take several minutes to obtain a single high quality graphic over a typical telephone line connection, and much longer to obtain audio or video clips.

Another problem with the World Wide Web is how to restrict access to particular websites to an audience deemed appropriate. This has to date most commonly involved websites with sexual content, which are deemed appropriate for “adults only.”

There are various proposals to deal with the problem of limited bandwidth. However, most of them involve additional hardware and/or wiring and thus significant additional expense in the delivery system, such as cable modem systems, which utilize the television cable network, Integrated Services Digital Network (ISDN) lines, or dedicated telephone lines for data, such as T1.

As to the other problems, some screening programs purport to limit access to certain Web sites, but these typically operate by looking for certain key words or content, a process subject to a noticeable error rate. With respect to payment, it is now known to have the user submit a credit card number over the Web and authorize charges to the card, but problems remain.

### SUMMARY OF THE INVENTION

In accordance with the illustrated preferred embodiment, the present invention provides an integrated system for coordinating a web site with a web browser using a storage medium which is local to the user, such as a CD-ROM, such that the user may interactively obtain information specified on the web site without experiencing great delays. The present invention also allows for control over the user's access to the data on the local storage medium, either by use of a password or an encryption key, without which the user cannot access the data.

Obtaining textual information with a web browser through a modem and a telephone connection does not create significant time delays. The problem lies with the other information desired in what is now known as multimedia, such as graphics, sound and video. But in many situations, the information desired by a user is permanent, i.e., it does not change over time. One type of permanent information is related to travel. For example, a user desires to obtain information about taking a vacation in New York City. A picture of the skyline of New York City is essentially permanent, as are pictures of many of the attractions there. On the other hand, statistics and other information about New York City, such as population, restaurants, hotel rates, ticket prices, etc., do change.

It is thus possible to divide the desired information into that which is permanent, or close enough to permanent that the user is not likely to care about the changes, and that which does significantly change. In addition, much of the permanent information is likely to be of the type that involves significant transmission time, such as graphics or video.

In one embodiment of the invention, the inventive browser will indicate to a web site that it has local access to a memory device, such as a CD-ROM, which the user has obtained in advance of contacting the web site and which contains information related to that found on the web site. Thereafter, when the user requests information which is on the CD-ROM, the website will not transmit that information, but rather will transmit a signal containing the address of the information on the CD-ROM.

In the travel situation described above, the user may see all of the graphic information, which is obtained from the CD-ROM, without experiencing the delays normally associated with graphics transmission. At the same time, current information about pricing, availability, etc., which is posted at the web site is obtained upon the user's request in the normal fashion.

Thus, the web site and the browser work in a coordinated fashion, indicating to each other that they are capable of utilizing the CD-ROM, and causing much of the permanent information to be accessed from the CD-ROM and not over the telephone lines. Because transmitting large files containing permanent information is time consuming, transmission time is drastically reduced and the user avoids a great deal of wait time. Further, if a significant portion of users use such a system, there is a time and resource saving “cascade effect,” in which the diminished demand for transmission bandwidth over the web causes all users to experience reduced delay times.

Many other uses of this system are envisioned. For example, in educational applications, pictures of animals, historical figures or events, paintings, or scientific drawings could all be located on a CD-ROM and accessed quickly, while information on the latest exhibitions, statistics, theories, or publications may be obtained from a web site in the conventional manner.

In another embodiment, this system can be used to control access to the CD-ROM, and prevent a user from obtaining information until an appropriate charge has been made for the requested material. In one version of this embodiment, the user must pay a one-time or periodic (such as monthly) fee in order to access the material on the web site and the CD-ROM. Once the fee is paid, access to the web site includes access to a password or encryption key needed to obtain the material on the CD-ROM, which is either password protected or encrypted.

In a different version of this embodiment, each item on the CD-ROM is protected by a different password or encryption key. The web site server contains information about which items the user has paid to obtain, and the browser is able to obtain the passwords or encryption keys for only those items.

It is also contemplated that the user may desire access to information which is semi-permanent, i.e., which changes over time but relatively slowly. For example, airline schedules change periodically, but typically not every day or week. While there are normally no graphics in time tables, there may be a large quantity of textual information, and use or incorporation of the present invention will result in significant time savings in obtaining such information. In such cases, the CD-ROM may be used, but replaced periodically with a new CD-ROM containing the current semi-permanent information. Access to the CD-ROM, and more current information such as current airfares, can then be obtained through the web site as described above.

The features and advantages described in the specification are not all inclusive, and particularly, many additional features and advantages will be apparent to one of ordinary skill in the art in view of the drawings, specification and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The aforementioned advantages of the invention, as well as additional advantages thereof, will be more fully understood as a result of a detailed description of a preferred embodiment when taken in conjunction with the accompanying drawings in which:

FIG. 1 is a simplified block diagram of the overall system of the invention; and

FIG. 2 is a flowchart of a simplified algorithm for implementing the present invention.

### DETAILED DESCRIPTION OF THE PREFERRED EMBODIMENT

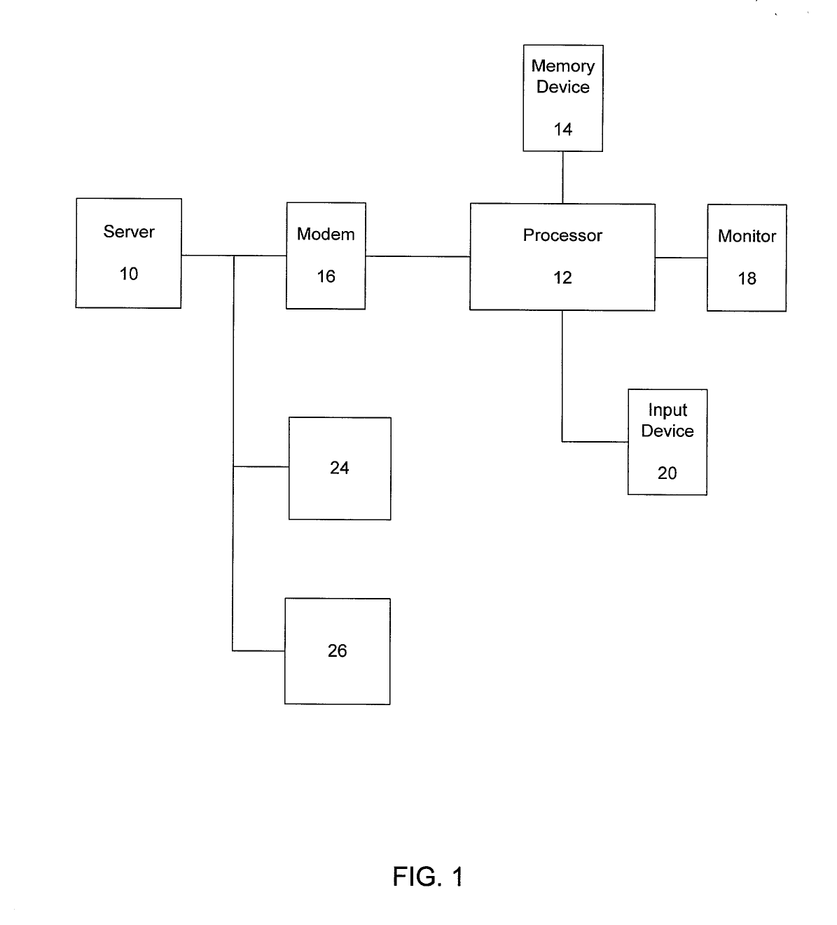

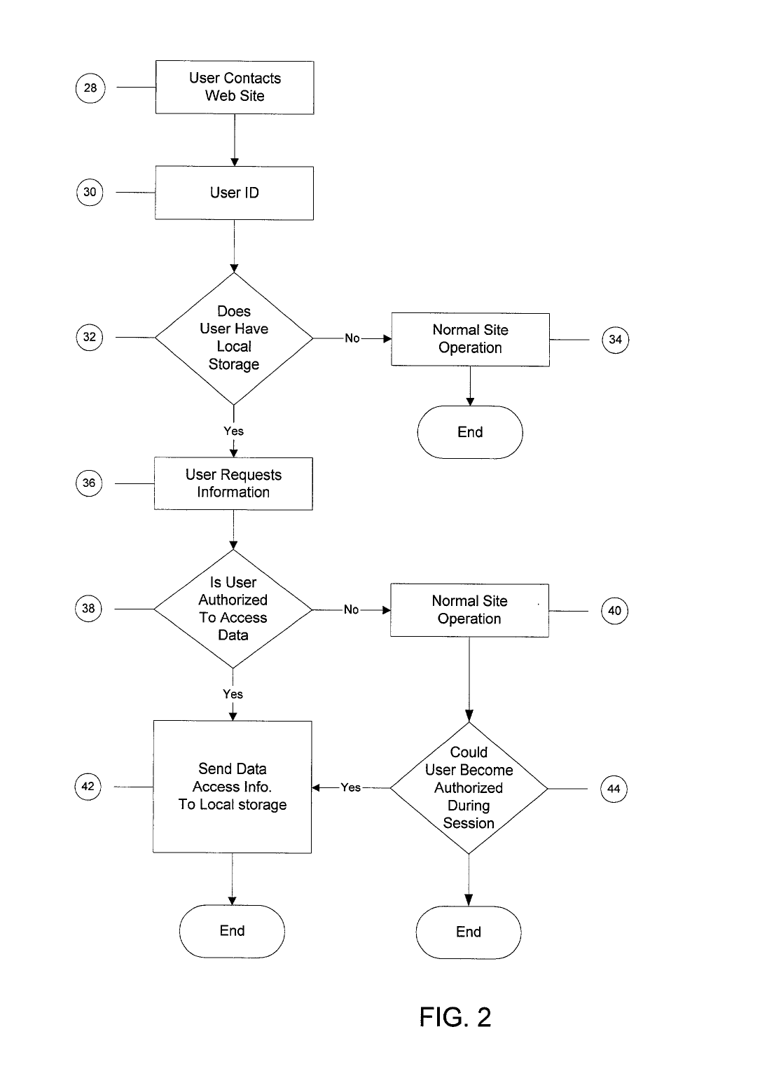

FIGS. 1 and 2 of the drawings depict various preferred embodiments of the present invention for purposes of illustration only. One skilled in the art will readily recognize from the following discussion that alternative embodiments of the structures and methods illustrated herein may be employed without departing from the principles of the invention described herein.

FIG. 1 is a simplified block diagram of the overall system of the present invention. A server 10 contains the hardware and software needed to create a website. A user activates a processor 12, which runs the browser software. Processor 12 may be a personal computer, or any other device which can utilize browser software, such as the “network appliances ” now being developed by several companies. Processor 12 can access a storage device 14, which may be a CD-ROM, a hard disk, a Zip® or Jazz® drive from Iomega, Inc., or any other addressable long term memory storage device. Even a floppy disk or read only memory (ROM) may be used, although these are not presently cost effective. (One can even contemplate using random access memory (RAM), although the RAM must be initially loaded from something else, and is again not presently cost effective.) It is believed that a CD-ROM presently offers the best combination of cost, access time, and storage capacity, and thus is now the preferred device, but this may change as new technologies are developed.

Processor 12 is also connected to a modem 16, which may be of the “internal” type which is contained within a personal computer, or “external” and connected to the processor through a cable, a monitor or screen 18 (which could be a television), and an input device 20, such as a keyboard or mouse. The browser on processor 12 accesses the web site on server 10 over public telephone lines 22 through modem 16. Other means for accessing the World Wide Web, such as cable modems which use the existing cable television infrastructure, could be used. Additional users with similar equipment at sites 24 and 26 may also access the website on server 10 through public telephone lines 22.

Storage device 14 contains information about the same general subject matter as the material located at the website on server 30. For example, memory device 14 may contain pictures of travel locations, attractions, and hotels, while the website contains information on current airfares, prices, availability or events. Thus, by the combination of information from both the storage device 14 and the website on server 10, the user is able to obtain current information about various travel locations, without having to wait for all of the information to be transmitted over the public telephone lines 22.

In typical operation, the user connects his site to the website on server 10 by using the modem 16 to place a call to the network on which server 10 resides, and then uses the browser to indicate the address (URL) of the desired website. Once the connection is made, the browser indicates to the website on server 10 that the user has access to memory device 14.

Through the use of the browser, the user may view the information on server 10. Server 10 also contains information indicating the contents of storage device 14, so that, when the user requests information from server 10 which is on storage device 14, the server can direct the user's browser to retrieve the requested data from storage device 14 rather than transmitting the data over telephone line 22. This results in much faster retrieval of the requested data.

If the user does not have storage device 14 containing the data specified on the website on server 10, then two possibilities exist. If server 10 contains the data requested, the data may be transmitted normally over telephone line 22. However, if server 10 does not contain the information, the user is simply unable to access the data without first obtaining the appropriate local storage device 14.

Similar results may be obtained with any type of data which is divisible into permanent, or semi-permanent, data and data which changes on a regular basis. Works of art, or pictures of animals or other items of nature, may be placed on the storage device 14, and information about current exhibits obtained from the website on server 10.

Educational programs are also possible. Geography and history may be handled just as travel, where the student user has a CD-ROM as storage device 14 which contains maps, photographs, or other material which does not change, and current information is obtained from the website on server 10. One can even envision a virtual school, with textbooks and other assigned reading materials contained on storage device 14, and current lectures and/or homework assignments obtained from the website on server 10.

The present invention may also be used with large amounts of permanent textual data as well as graphics or other non-textual data, to avoid having to download large databases. In addition, in the case of semi-permanent data, the storage device 14 may be updated periodically. As an example of both of these, a new CD-ROM may be sent out at regular intervals to update airline schedules, with current fares obtained from a website on server 10.

By the use of this invention, relatively little information needs to be downloaded from the website on server 10, and thus the desired information is available much more readily than if all of it had to be downloaded.

It is also contemplated that access to the data on storage device 14 may be controlled by means of password protection or encryption, with access provided by the transmission of the necessary password or encryption key along with the address of the desired data. That is, when the user requests data which is contained on the storage device 14, the program on server 10 can check to see if the user is authorized to access the requested data, and only transmit the information necessary to access the data if the user has satisfied some prerequisite.

For example, the vendor providing the website may choose to charge for access to certain data, by requiring payment by the user before access is granted.

This may be accomplished either by the user sending in payment before accessing the website, or by transmitting authorization to charge a credit card during the session in which the website is accessed. The program on the server can then compare the user's name to a list of authorized names and release the needed password or encryption key only if the user has submitted payment.

This type of controlled access can be granted even more specifically. That is, it is not necessary to grant or deny access to the entire storage device 14 in a single transaction. Rather, the storage device 14 may contain a plurality of items, each of which may be the subject of a separate password or encryption key, and each of which thus requires a separate payment transaction. The user is able to determine which items he or she is willing to pay for, and pay for only those items, rather than paying a fee which may be larger to access the entire storage device 14 if some of the data contained thereon is not of interest to the user.

A simple algorithm for providing access to the local storage device 14 is shown in FIG. 2. In step 28 the user contacts the website on server 10 by using a browser over public telephone line 22 via modem 16. Upon connecting, a user identification is transmitted to the website at step 30.

The program on server 10 then queries the user's browser at step 32 to determine whether the user has access to a local storage medium 14. If the user does not have such access, the website operates in normal fashion at step 34. In this mode, depending upon the vendor's desires, the user may be permitted to request information which may be transmitted normally, or the user may be told that the information is not available until a local storage device 14 is obtained. Further, this normal operation may also be subjected to an authorization check as further described below.

If it is determined at step 32 that the user does have a local storage device 14, the user at step 36 may then submit a request for information specified on the website on server 10 and located on local storage device 14. The program on server 10 may then determine whether the user is entitled to obtain the requested data, for example by comparing the user's identification to a list of users who have previously submitted the appropriate payment.

If the user is so authorized, at step 42 the server 10 transmits the information necessary for the user to obtain the requested information from local storage device 14, which may consist of, for example, the address on the CD-ROM at which the information is located, and the password or encryption key needed to access the data at that address.

If the user is not authorized to obtain the requested data the server 10 can transmit a message informing the user of this fact at step 40. Here again, depending upon the intent of the vendor of the website on server 10, the user may be invited to transmit authorization to charge a credit card during the same connection at step 44, and access thereupon granted at step 42 as above.

From the above description, it will be apparent that the invention disclosed herein provides a novel and advantageous apparatus for increasing the speed of access to data specified in a website, and for controlling access to that data based upon predetermined criteria.

The foregoing discussion discloses and describes merely exemplary methods and embodiments of the present invention. As will be understood by those familiar with the art, the invention may be embodied in other specific forms without departing from the spirit or essential characteristics thereof. For example, the user may be given a password to use in accessing the site which serves as proof that authorization has been granted, in which case it is not necessary for server 10 to compare the user's individual identification to a list of authorized users. Other permutations of the above principles are also intended to be included. Accordingly, the disclosure of the present invention is intended to be illustrative, but not limiting, of the scope of the invention, which is set forth in the following claims.

What is claimed is:

1. A system for increasing the speed at which data specified in an Internet web site can be retrieved, comprising:
a local storage medium containing a plurality of data specified in the Internet web site;
receiving means for obtaining information from the Internet web site which specifies which of the plurality of data is to be retrieved; and
retrieval means coupled to the receiving means and the local storage medium for accessing the local storage medium to retrieve the data.

2. The system of claim 1 wherein the local storage medium is a CD-ROM, and the means for accessing the local storage medium is a CD-ROM drive.

3. The system of claim 1 wherein the means for obtaining information from the Internet web site is a processor and an Internet web browser.

4. The system of claim 1 wherein the Internet web site contains information necessary to access the specified data, the plurality of data in the local storage medium cannot be accessed without such information, and the means for obtaining information from the Internet web site further comprises means for obtaining the information necessary to access the specified data.

5. The system of claim 4 wherein the information necessary to access the specified data includes a password.

6. The system of claim 5 wherein the means for obtaining the information necessary to access the specified data is a processor and an Internet web browser.

7. The system of claim 4 wherein the specified data is encrypted, and the information necessary to access the specified data includes an encryption key needed to decrypt the specified data.

8. The system of claim 7 wherein the means for obtaining the information necessary to access the specified data is a processor and an Internet web browser.

9. A system for controlling retrieval of data specified in an Internet web site having a server end, a user site, and means for carrying data coupled between the server end and the user site, comprising:
a local storage medium coupled to the user site containing a plurality of data configured to be specified by the Internet web site;
means at the user site for providing information to the server and regarding an identified user, indicating that the user site has the local storage medium, and for interfacing with the server and to form a request for some or all of the plurality of data;
means at the server end for ascertaining whether the identified user is authorized to access the requested data;
means at the server end for providing information from the Internet web site in response to the request which specifies which of the plurality of data is to be retrieved in response to the request, if the user is authorized to access the data;
means at the user site for accessing the local storage medium for retrieving the requested data.

10. The system of claim 9, wherein the local storage medium is a CD-ROM and the means for accessing the local storage medium is a CD-ROM drive.

11. The system of claim 9 wherein the means at the user site for providing information to the server end is an Internet web browser.

12. The system of claim 9, wherein the ascertaining means is a program which compares the information identifying the user to a list of authorized users.

13. The system of claim 9, wherein the plurality of data is password protected, and the information provided from the Internet web site which specifies which of the plurality of data is to be retrieved includes the password needed to access the specified data.

14. The system of claim 9, wherein the plurality of data is encrypted, and the information provided from the Internet web site which specifies which of the plurality of data is to be retrieved includes the encryption key needed to decrypt the specified data.

15. A method of controlling retrieval by a user system having a local storage medium containing a plurality of data specified in an Internet web site, comprising:
identifying the user when the user accesses the web site;
determining that the user system has the local storage medium;
receiving a request for some of all of the plurality of data;
ascertaining whether the user is authorized to access the requested data; and
providing information from the Internet web site which specifies which of the plurality of data is to be retrieved, the user is authorized to access the data.

16. The method of claim 15, wherein the step of providing a local storage medium further comprises providing a CD-ROM.

17. The method of claim 15, wherein the step of ascertaining whether the user is authorized to access the requested data further comprises comparing the information identifying the user to a list of authorized users.

18. The method of claim 15, wherein the plurality of data is password protected, and the step of providing information from the Internet web site which specifies which of the plurality of data is to be retrieved includes providing the password needed to access the specified data.

19. The method of claim 15, wherein the plurality of data is encrypted, and the step of providing information from the Internet web site which specifies which of the plurality of data is to be retrieved includes providing the encryption key needed to decrypt the specified data.
